(19) United States
(12) Patent Application Publication
(10) Pub. No.: US 2019/0079644 A1
(43) Pub. Date: Mar. 14, 2019

(54) METHOD FOR PROVIDING TRANSLATION WITH EMOTICON, USER TERMINAL, SERVER AND COMPUTER PROGRAM

(71) Applicant: NAVER Corporation, Seongnam-si (KR)

(72) Inventors: Junseok KIM, Seongnam-si (KR); Jiwoon JUNG, Seongnam-si (KR)

(21) Appl. No.: 16/185,740

(22) Filed: Nov. 9, 2018

Related U.S. Application Data
(63) Continuation of application No. PCT/KR2017/003995, filed on Apr. 13, 2017.

(30) Foreign Application Priority Data
May 9, 2016 (KR) 10-2016-0056378

(51) Int. Cl. G06F 3/0482; G06F 17/28; G06F 3/0481; G06F 3/0484; G10L 13/04

(52) U.S. Cl. CPC G06F 3/0482; G06F 17/289; G10L 13/043; G06F 3/0484; G06F 3/04817

(57) ABSTRACT

The present invention relates to a method, a user terminal, a server, and a computer program for providing a translation to a user, and more particularly, to a method for providing an original text and a translation thereof in a user terminal, including: receiving, by the user terminal, an original text from a user; performing an emoticon presenting and selecting operation of presenting, by the user terminal, emoticons classified by a plurality of items and allowing the user to select an emoticon; and providing, by the user terminal, the selected emoticon together with the original text and a translation thereof.

### CROSS-REFERENCE TO RELATED APPLICATIONS

This is a continuation application of International Application No. PCT/KR2017/003995, filed Apr. 13, 2017, which claims benefit of Korean Patent Application No. 10-2016-0056378, filed May 9, 2016.

### BACKGROUND OF THE INVENTION

### Field of Invention

The present invention relates to a method, a user terminal, a server, and a computer program for providing a translation, and more particularly, to a method, a user terminal, a server, and a computer program for providing a translation, wherein, in providing a translation of an original text, a user can conveniently select and provide an emoticon corresponding to the original text or the translation thereof, thereby effectively expressing a user's intended emotion together with the translation.

### Description of Related Art

Recently, users who use interpretation or translation applications or programs operated by terminals such as smartphones or PCs have been increasing. Therefore, various attempts have been made to implement more efficient interpretation and translation algorithms for the user. For example, Korean Patent Publication No. 10-2011-0112192 discloses a machine translation system and method based on syntax analysis and hierarchical phrase model.

However, the interpretation and translation algorithm that can be implemented at the current level of technology is not yet able to naturally interpret and translate one language into another language. Due to this, it is impossible to provide a natural translation for an original text requested for translation. Therefore, unlike what a user wants, a somewhat rigid translation may be provided, or a user's intention may not be correctly transmitted.

Furthermore, the human language can express and transmit not only simple meaning but also emotion, and the user not only wants to transmit a correctly translated sentence but also a translation to express the emotions that he or she wants to express effectively.

Therefore, there is a need for accurate translation of the original text, and a method for expressing the emotions associated with the original text effectively. However, appropriate solutions are not yet available.

### BRIEF SUMMARY OF THE INVENTION

The present invention has been made to solve the above-mentioned problems of the conventional art, and it is an object of the present invention to provide a method, a user terminal, a server, and a computer program for providing a translation, wherein a user can conveniently select and provide emoticons corresponding to an original text and a translation thereof together with the original text and the translation thereof.

It is another object of the present invention to provide a method, a user terminal, a server, and a computer program for providing a translation, wherein a translation can be converted into a voice (a speech sound) by reflecting an emotion that a user wants to express.

To solve the above problems, a method for providing an original text and a translation thereof in a user terminal according to an aspect of the present invention includes: receiving, by the user terminal, an original text from a user; performing an emoticon presenting and selecting operation of presenting, by the user terminal, emoticons classified by a plurality of items and allowing the user to select an emoticon; and providing, by the user terminal, the selected emoticon together with the original text and a translation thereof.

In addition, a method by which a server provides an original text and a translation thereof by using a user terminal according to another aspect of the present invention includes: receiving, by the server, an original text inputted by a user from the user terminal; providing, by the server, emoticons classified by a plurality of items to the user terminal; and providing, by the server, a translation of the original text to the user terminal.

A computer program according to another aspect of the present invention is a computer program for executing each operation of the translation providing method on a computer.

A user terminal for providing an original text and a translation thereof according to another aspect of the present invention includes: an original text inputting unit configured to receive an original text from a user; an emoticon presenting and selecting unit configured to classify and present emoticons by a plurality of items and allow the user to select an emoticon; and a result providing unit configured to provide the selected emoticon together with the original text and a translation thereof.

A server for providing an original text and a translation thereof by using a user terminal according to another aspect of the present invention includes: an original text receiving unit configured to receive an original text inputted by a user from the user terminal; an emoticon providing unit configured to provide emoticons classified by a plurality of items to the user terminal; and a translation providing unit configured to provide a translation of the original text to the user terminal.

According to one embodiment of the present invention, in receiving an original text and providing a translation thereof to a user, emoticons classified by a plurality of emotional items are presented, an emoticon is selected from the user, and the selected emoticon is provided together with the original text and the translation thereof. Therefore, it is possible not only to provide a simple translation but also to effectively express an emotion intended by the user.

In addition, according to one embodiment of the present invention, one or more emoticons expected to be selected by the user is recommended by using a word or a sentence included in the original text or the translation. Therefore, the user can more easily select and provide the emoticon corresponding to the original text and the translation.

Furthermore, according to one embodiment of the present invention, a translation differently converted into a voice by reflecting the emotion of the selected emoticon is provided. Therefore, the user can be provided with a translation converted into a voice by reflecting the emotion that the user desires to express.

### BRIEF DESCRIPTION OF THE DRAWINGS

FIG. 1 is a configuration diagram of a translation providing system according to an embodiment of the present invention.

FIG. 2 is a flowchart of a translation providing method based on a user terminal according to an embodiment of the present invention.

FIG. 3 is an exemplary view of a user interface for selecting an emoticon in a user terminal according to an embodiment of the present invention.

FIG. 4 is an exemplary diagram of emoticons classified based on a plurality of emotion items according to an embodiment of the present invention.

FIG. 5 is an exemplary view of a user interface for selecting a translation expansion screen according to an embodiment of the present invention.

FIG. 6 is an exemplary view of a translation expansion screen according to an embodiment of the present invention.

FIG. 7 is an explanatory view for explaining a process of calculating an emoticon corresponding to an original text according to an embodiment of the present invention.

FIG. 8 is an exemplary view of an emoticon calculated and recommended from an original text according to an embodiment of the present invention.

FIG. 9 is an exemplary view of a screen in which an emoticon corresponding to an original text is selected, according to an embodiment of the present invention.

FIGS. 10 and 11 are diagrams illustrating examples of a screen in which a translation is converted into a voice by reflecting an emotion of a selected emoticon, according to an embodiment of the present invention.

FIG. 12 is a flowchart of a translation providing method based on a server according to an embodiment of the present invention.

FIG. 13 is a configuration diagram of a user terminal for providing a translation according to an embodiment of the present invention.

FIG. 14 is a configuration diagram of a server for providing a translation according to an embodiment of the present invention.

### DETAILED DESCRIPTION OF THE INVENTION

Various alterations and modifications may be made to the embodiments, some of which will be illustrated in detail in the drawings and detailed description.

However, in the following descriptions, descriptions of well-known techniques will be omitted if they are considered to unnecessarily obscure the gist of the present invention.

It will be understood that although the terms “first”, “second”, etc. may be used herein to describe various components, these components should not be limited by these terms. These components are only used to distinguish one component from another.

Hereinafter, exemplary embodiments of a method, a user terminal, a server, and a computer program for providing a translation according to the present invention will be described in detail with reference to the accompanying drawings.

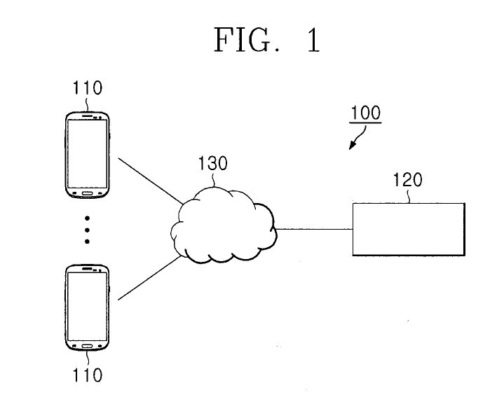

FIG. 1 is a configuration diagram of a translation providing system 100 according to an embodiment of the present invention. As illustrated in FIG. 1, the translation providing system 100 according to the embodiment of the present invention may include: a plurality of user terminals 110 for receiving an original text from a user and providing a translation of the original text, wherein any of the user terminals 110 may provide a user with emoticons classified by a plurality of emotion items and provide an emoticon selected by the user together with the original text and the translation, thereby capable of effectively transmitting an emotion to be expressed by the user; a server 120 for receiving the original text inputted by the user from the user terminal 110, calculating the translation thereof, providing the translation to the user terminal 110, and providing the emoticons classified by the plurality of emotion items to the user terminal 110; and a network 130 for connecting the user terminal 110 and the server 120.

Furthermore, in providing the emoticon to the user, the emoticons are not necessarily classified by the plurality of emotional items and then provided, and the emoticons may be classified by various criteria and then provided.

As the user terminal 110, various mobile terminals such as a smartphone, a tablet PC, a PDA, and a mobile phone can be used. In addition, various terminals that can be used for receiving original texts from a user such as a personal computer (PC) or a notebook PC and providing predetermined emoticon together with the original text and the translation thereof can be adopted.

Furthermore, in the present invention, the user terminal 110 does not necessarily perform the translation of the original text with the aid of the server 120, and the user terminal 110 may independently perform the translation of the original text.

In addition, the emoticons in the present invention is not limited to an image, a picture, a photograph, and the like. The emoticons may include a text, a symbol, a figure, or the like, or may include a moving image or the like.

In addition, the network 130 for connecting the user terminal 110 and the server 120 may include a wired network and a wireless network. Specifically, the network 130 may include various communication networks such as a local area network (LAN), a metropolitan area network (MAN), or a wide area network (WAN). In addition, the network 130 may include known World Wide Web (WWW). However, the communication network 130 according to the present invention is not limited to the networks listed above, and may include at least part of a known wireless data network, a known telephone network, or a known wired/wireless television network.

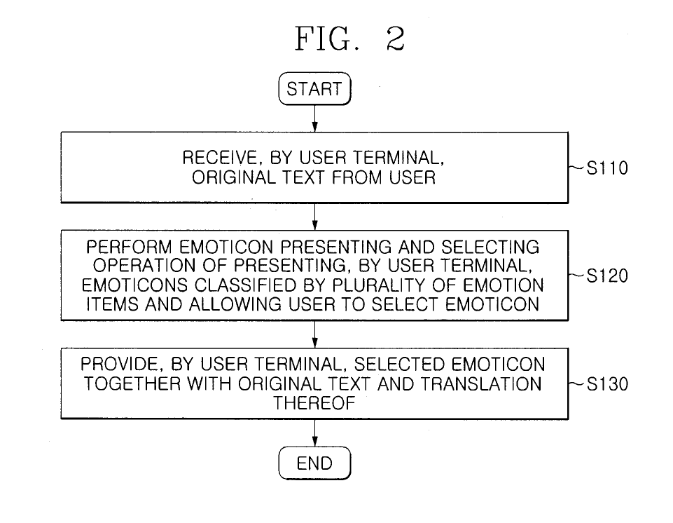

FIG. 2 is a flowchart of a translation providing method performed by the user terminal 110 according to an embodiment of the present invention. Hereinafter, a translation providing method according to an embodiment of the present invention will be described step by step with reference to FIG. 2.

First, in operation S110, the user terminal 110 receives an original text to be translated from a user.

At this time, the user terminal 110 may provide a user interface for allowing the user to input the original text, and may further provide a user interface for selecting a language of the original text and a language of the translation. For example, the user can select Korean as the original text and select Chinese as the translation, and thus input the original text to be translated in Korean.

Next, in operation S120, the user terminal 110 presents the emoticons classified by a plurality of emotional categories (for example, “sorry”, “happy”, “shy” and etc.), and recognizes the emoticon selected from the presented emoticons by the user.

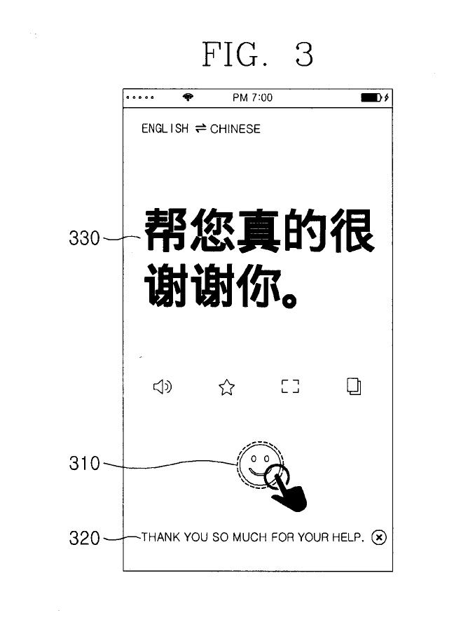

As a specific embodiment, FIG. 3 illustrates a user interface on a screen of the user terminal 110 for allowing a user to select a predetermined icon 310 so as to select an emoticon. As illustrated in FIG. 3, the user terminal 110 may provide a predetermined icon 310 or menu so as to allow a user to select the icon 310. When the user selects the provided icon 310 or menu by using a pointer or the like, the user terminal 110 presents the emoticons classified by the plurality of emotional categories to the user.

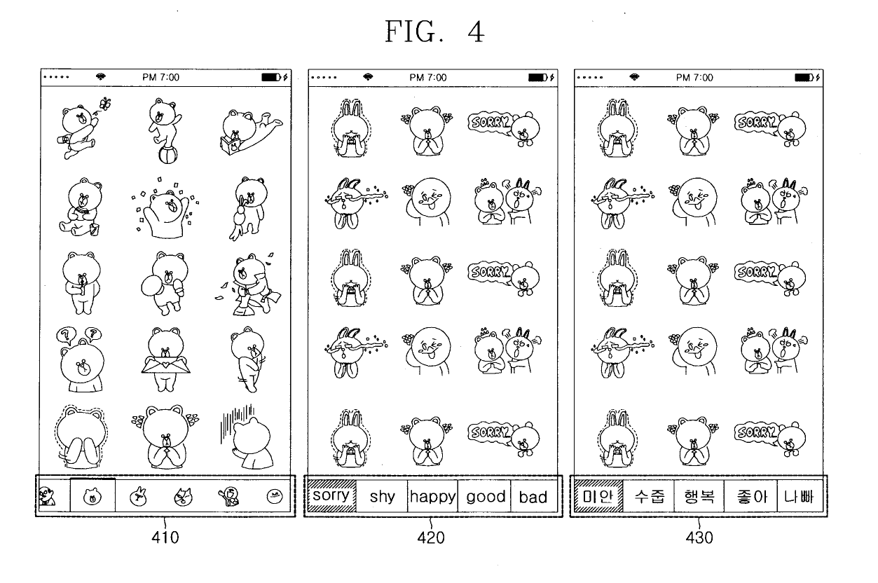

FIG. 4 illustrates a screen on the user terminal 110 for presenting the emoticons classified by the plurality of emotional categories as described above.

In a conventional messenger application or the like, emoticons are generally classified by the sort of emoticons 410 and then provided. However, according to the present invention, the emoticon capable of expressing the user's emotion is classified by plurality of emotional categories 420 (for example, “sorry”, “shy”, “happy”, “good”, or “bad” as illustrated in an example of FIG. 4 and then provided, whereby the user can select the emoticon corresponding to the emotion to be expressed by the user in a very simple manner.

More specifically, as can be seen from FIG. 4, the user terminal 110 may present the plurality of emotional categories that the user can select in a first region 420 of the screen and may present the emoticons classified by the plurality of emotional categories in a second region 430 of the screen.

In addition, the emotional categories may be displayed in another language such as English, Japanese, or Chinese, according to the environment setting in the user terminal 110 (430). Furthermore, when the user changes the language setting of the original text, the display of the emotional categories may be changed accordingly.

In addition, the user may change the display order or phrases of the emotional categories according to the user's preference, and the user may select some categories preferred among the plurality of emotional categories and first display the selected categories.

Furthermore, some or all of the emoticons presented to the user may be emoticons whose shape changes with time. When the shape of the emoticon changes, it is possible to more effectively express the emotion of the user.

Then, in operation S130, the user terminal 110 provides the selected emoticon together with the original text and the translation thereof.

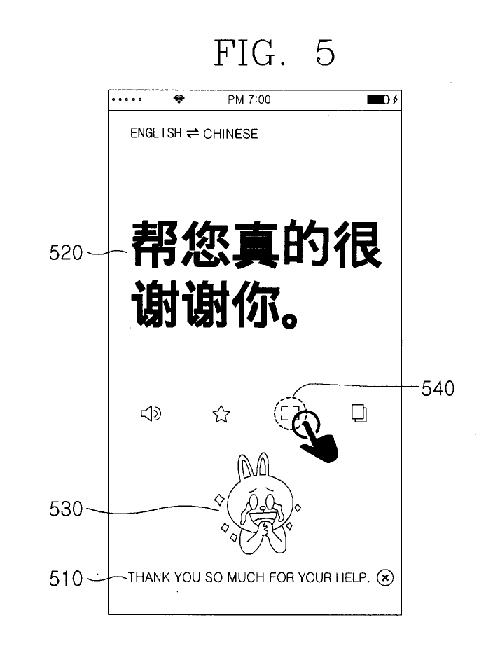

More specifically, FIG. 5 illustrates a screen on which a selected emoticon 530 is provided together with an original text 510 and a translation 520 thereof.

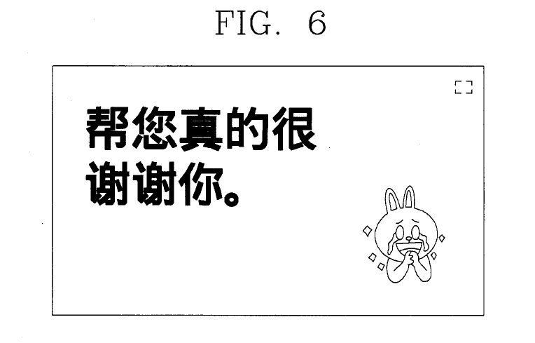

At this time, when the user selects a predetermined menu or the like 540, the user can be provided with an enlarged screen including the translation and the emoticon as illustrated in FIG. 6. The enlarged screen may also include the original text.

Accordingly, since the user conveniently selects the emoticon corresponding to the emotion (for example, sorry or happy) that he or she wants to express and is provided with the emoticon together with the original text and the translation thereof, it is possible not only to provide a simple translation but also to effectively express the emotion intended by the user.

The translation providing method based on the user terminal 110 according to the embodiment of the present invention may further include operation in which the user terminal 110 recommends, to the user, at least one emoticon expected to be selected by the user by using a word or a sentence included in the original text or the translation.

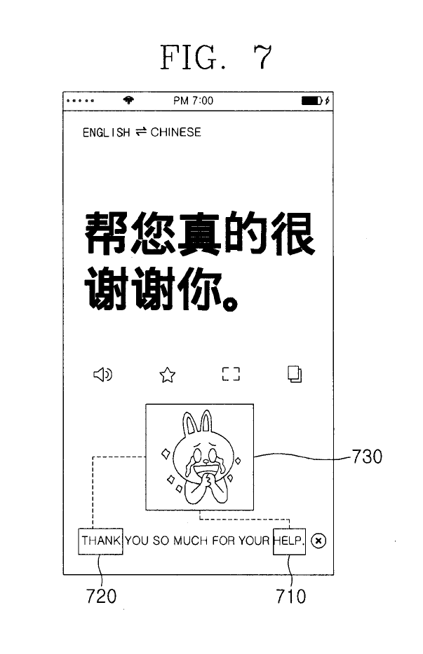

More specifically, FIG. 7 illustrates a diagram for explaining a process of calculating an emoticon corresponding to an original text inputted by a user. As can be seen from FIG. 7, the user can input an original text “Thank you so much for your help” and obtain a translation thereof. At this time, considering the word included in the original text (for example, “help” 710, “thank” 710, or the like in FIG. 7), the user terminal 110 may calculate one or more emoticons 730 corresponding to the word and recommend the emoticon to the user.

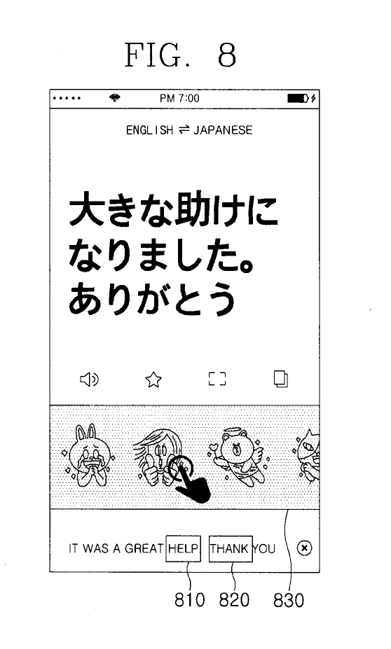

Furthermore, as can be seen from FIG. 8, after calculating one or more emoticons corresponding to one or more words (“help” 810 and “thank” 820 in FIG. 8) included in the original text (“It was a great help. Thank you”) inputted by the user, the selected one or more emoticons may be presented to the user in a descending order of a predetermined evaluation value such as a selection probability of the user. In addition, the calculated one or more emoticons may be classified by the plurality of emotional categories and then provided.

In addition, in calculating one or more emoticons to be provided to the user, the one or more emoticons may be calculated by using location information of the user terminal 110. For example, when the user is located at an airport or a shopping mall, emoticons frequently used at the airport or shopping mall may be chosen with statistical approach and provided to the user.

Furthermore, in calculating one or more emoticons to be recommended to the user by using the original text inputted by the user or the location information of the user terminal 110, the one or more emoticons may be calculated by using a classifier learned by machine learning. More specifically, the classifier can be implemented based on various machine learning techniques such as Logistics Regression, Bayesian network, AdaBoost, Support Vector Machine (SVM), and Naive Bayes.

At this time, the classifier may be driven in the server 120, and if necessary, may be driven in the user terminal 110.

When the classifier is driven in the server 120, the user terminal 110 transmits, to the server 120, the original text inputted by the user or the location information of the user terminal 110, and the user terminal 110 receives one or more emoticons calculated by the classifier from the server 120 and provides the emoticons to the user.

The classifier continuously learns the emoticons selected by the user from the given original text and the location information, so as to produce personalized and optimized results for each user.

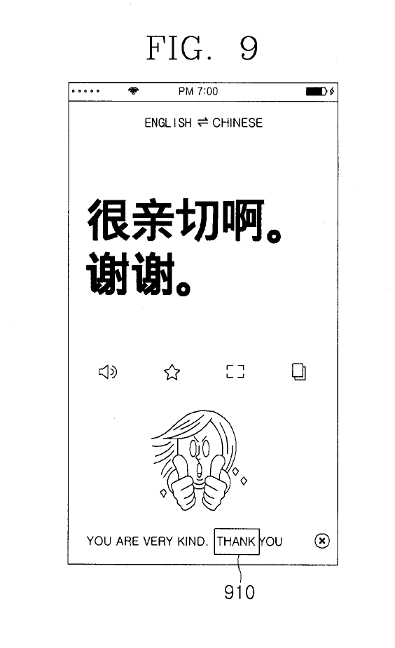

Therefore, as illustrated in FIG. 9, by recommending one or more emoticons calculated from the word “Thank” included in the original text “You are very kind. Thank you” inputted by the user, the user can more easily select and provide the emoticons corresponding to the original text and the translation.

In addition, the translation providing method based on the user terminal 110 according to the embodiment of the present invention may further include operation in which the user terminal 110 provides the translation converted into a voice by reflecting the emoticon selected by the user.

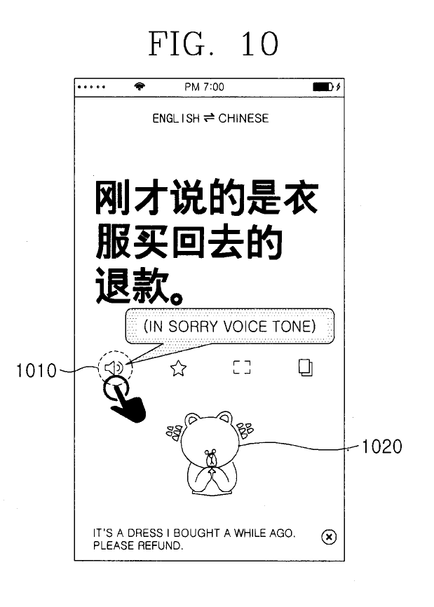

For example, in FIG. 10, since the emoticon selected by the user is an emoticon corresponding to “sorry”, the translation can be converted into a “sorry” voice tone conveying a sense of regret or remorse and outputted.

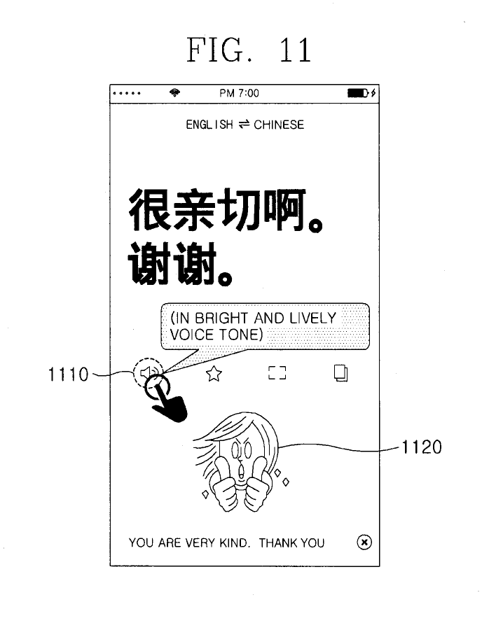

On the other hand, in FIG. 11, since the emoticon selected by the user is an emoticon corresponding to “good”, the translation can be converted into a bright and lively voice tone and outputted.

More specifically, the translation may be converted into a voice by using voice conversion data corresponding to the selected emotions among a plurality of voice conversion data according to the plurality of emotional categories stored in the database 140.

At this time, the database 140 may be driven in the server 120, and if necessary, may be driven in the user terminal 110.

When the database 140 is driven in the server 120, the user terminal 110 transmits, to the server 120, information about the original text inputted by the user and the emoticon selected by the user.

At this time, the server 120 can convert the translation into the voice by using the voice conversion data corresponding to the emotional category (for example, “sorry” in FIG. 10 or “good” in FIG. 11) of the emoticon selected by the user among the plurality of voice conversion data stored in the database 140.

Furthermore, the database 140 may include a plurality of first voice conversion data classified according to the plurality of emotional categories, and second voice conversion data commonly used regardless of the plurality of emotional categories.

In this case, since the capacity of the voice conversion data included in the database 140 can be greatly reduced, the cost for manufacturing the database 140 can be reduced, and the computer resources consumed for driving the database 140 can be reduced.

Therefore, it is possible to provide the translations differently converted into voices by reflecting the emotions of the selected emoticons, and the user can receive the voice-converted translations in which the emotion to be expressed is reflected.

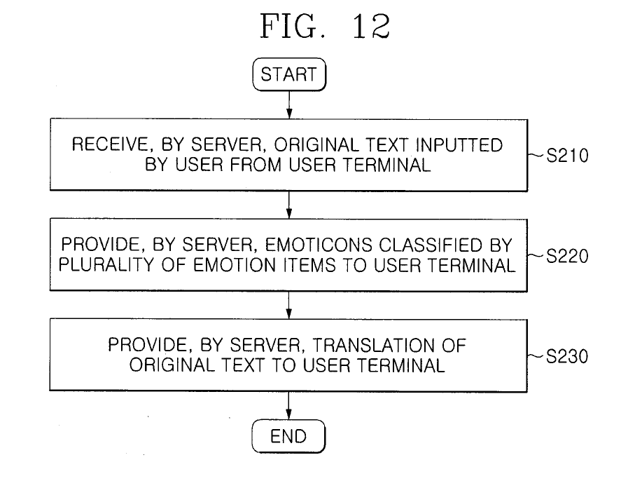

FIG. 12 is a flowchart of a translation providing method based on the server 120 according to an embodiment of the present invention. Hereinafter, a translation providing method according to an embodiment of the present invention will be described step by step with reference to FIG. 12.

First, operation S210 will be described. In operation S210, the server 120 receives the original text inputted by the user from the user terminal 110.

That is, as described above, the user terminal 110 may provide the user interface for allowing the user to input the original text, collect the original text inputted by the user, and then transmit the original text to the server 120.

Therefore, the server 120 can calculate the translation of the original text inputted by the user.

Next, in operation S220, the server 120 provides the emoticons classified by the plurality of emotion items to the user terminal 110.

In this case, operation S220 is not necessarily performed after operation S210, and the server 120 may transmit, to the user terminal 110, the emoticons classified by the plurality of emotion items in advance.

Therefore, the user terminal 110 may provide the emoticons classified by the plurality of emotion items to the user, and recognize the emoticon selected by the user.

Finally, in operation S230, the server 120 provides the translation of the original text to the user terminal 110.

Therefore, the user terminal 110 may provide the user with the emoticon selected corresponding to the original text or the translation together with the original text and the translation.

Furthermore, the translation providing method based on the server 120 according to the embodiment of the present invention may further include operation in which the server 120 transmits, to the user terminal 110, a list of one or more emoticons expected to be selected by the user by using a word or a sentence included in the original text or the translation.

The translation providing method based on the server 120 according to the embodiment of the present invention may further include operation in which the server 120 calculates one or more emoticons to be recommended to the user by using the location information of the user terminal 110.

At this time, in calculating one or more emoticons to be recommended to the user by using the original text inputted by the user or the location information of the user terminal 110, the one or more emoticons may be calculated by using a classifier learned by machine learning.

Furthermore, the translation providing method based on the server 120 according to the embodiment of the present invention may further include operation of providing the translation converted into the voice by reflecting the emoticon selected by the user.

In addition, a computer program according to another aspect of the present invention is a computer program stored in a computer-readable medium so as to execute each operation of the translation providing method. The computer program may be not only a computer program including machine language codes prepared by a compiler but also a computer program including high-level codes executable by a computer by using an interpreter. At this time, the computer is not limited to a personal computer (PC), a notebook computer, or the like, and may include any information processing device including a central processing unit (CPU), such as a server, a smartphone, a tablet PC, a PDA, or a mobile phone, capable of executing the computer program. In addition, the computer-readable medium may continuously store a computer-executable program, or may temporarily store the computer-executable program for execution or download. In addition, the medium may be a variety of recording means or storage means in the form of single hardware or a combination of a plurality of hardware, but is not limited to a medium directly connected to any computer system. For example, the medium may be distributed on a network. The medium may be configured to store program instructions, and example of the medium may include magnetic media (e.g., hard disk, floppy disk, magnetic tape, etc.), optical media (e.g., compact disc-read-only memory (CD-ROM), digital versatile disk (DVD), etc.), magneto-optical media (e.g., floptical disk, etc.), and read-only memory (ROM), random access memory (RAM), and flash memory. Another example of the medium may include a recording medium or a storage medium managed by an application store that distributes applications or a site or a server that supplies or distributes a variety of other software. In addition, the present invention may also be embodied in the form of a recording medium on which a computer program is stored.

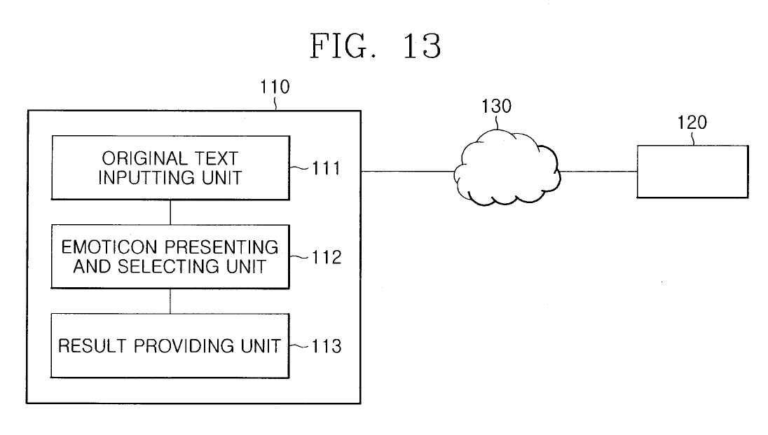

In addition, FIG. 13 is a configuration diagram of the user terminal 110 for providing the translation according to an embodiment of the present invention.

As illustrated in FIG. 13, the user terminal 110 for providing the translation according to the embodiment of the present invention may include an original text inputting unit 111, an emoticon presenting and selecting unit 112, and a result providing unit 113.

Hereinafter, each component of the user terminal 110 for providing the translation according to the embodiment of the present invention will be described. Since details of the user terminal 110 for providing the translation according to the embodiment of the present invention can be inferred from the description of the above-described translation providing method according to the embodiment of the present invention, a more detailed description thereof will be omitted. The original text inputting unit 111, the emoticon presenting and selecting unit 112, and the result providing unit 113 can be composed of a processor, a display and software executed in the processor. For example, they may be implemented with a mobile terminal (smart phone or tablet PC etc.) and software application installed and executed in the mobile terminal.

Hereinafter, each component of the user terminal 110 for providing the translation according to the embodiment of the present invention will be described. Since details of the user terminal 110 for providing the translation according to the embodiment of the present invention can be inferred from the description of the above-described translation providing method according to the embodiment of the present invention, a more detailed description thereof will be omitted.

First, the original text inputting unit 111 receives the original text from the user.

Then, the emoticon presenting and selecting unit 112 classifies and presents a plurality of emoticons according to emotional items, such that the emoticon is selected by the user.

Finally, the result providing unit 113 provides the selected emoticon together with the original text and the translation thereof.

Furthermore, the user terminal 110 for providing the translation according to the embodiment of the present invention may recommend, to the user, a list of one or more emoticons calculated by using a word or a sentence included in the original text or the translation.

In addition, the user terminal 110 for providing the translation according to the embodiment of the present invention may recommend, to the user, one or more emoticons calculated by using the location information of the user terminal 110.

At this time, a classifier learned by machine learning may be used in calculating one or more emoticons to be recommended to the user by using the original text inputted by the user or the location information of the user terminal 110.

Furthermore, the user terminal 110 for providing the translation according to the embodiment of the present invention may provide the translation converted into the voice by reflecting the emoticon selected by the user.

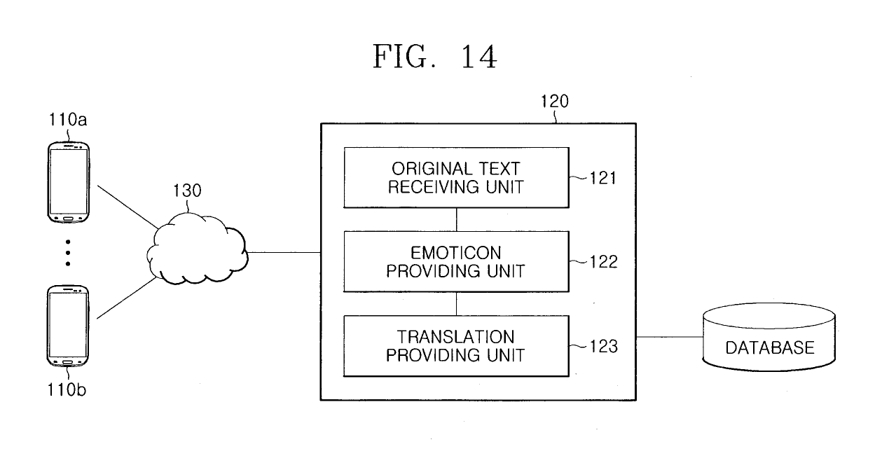

In addition, FIG. 14 is a configuration diagram of the server 120 for providing the translation according to an embodiment of the present invention.

As illustrated in FIG. 14, the server 120 for providing the translation according to the embodiment of the present invention may include an original text receiving unit 121, an emoticon providing unit 122, and a translation providing unit 123.

Hereinafter, each component of the server 120 for providing the translation according to the embodiment of the present invention will be described. Since details of the server 120 for providing the translation according to the embodiment of the present invention can be inferred from the description of the above-described translation providing method according to the embodiment of the present invention, a more detailed description thereof will be omitted. The original text receiving unit 121, the emoticon providing unit 122, and the translation providing unit 123 can be composed of a processor, a display and software executed in the processor. For example, they may be implemented with a mobile terminal (smart phone or tablet PC etc.) and software application installed and executed in the mobile terminal.

First, the original text receiving unit 121 receives the original text inputted by the user from the user terminal 110.

In addition, the emoticon providing unit 122 provides the emoticons classified by the plurality of emotion items to the user terminal 110.

Finally, the translation providing unit 123 provides the translation of the original text to the user terminal 110.

Furthermore, the server 120 for providing the translation according to the embodiment of the present invention may calculate a list of one or more emoticons by using a word or a sentence included in the original text or the translation and transmit the list of one or more emoticons to the user terminal 110.

In addition, the server 120 for providing the translation according to the embodiment of the present invention may calculate one or more emoticons to be recommended to the user by the location information of the user terminal 110.

At this time, a classifier learned by machine learning may be used in calculating one or more emoticons to be recommended to the user by using the original text inputted by the user or the location information of the user terminal 110.

Furthermore, the server 120 for providing the translation according to the embodiment of the present invention may calculate the translation converted into the voice by reflecting the emoticon selected by the user.

At this time, the server 120 may calculate the translation of the original text inputted by the user, or may use a predetermined database 140 to perform the voice conversion of the translation.

The above description is merely illustrative of the technical idea of the present invention, and various modifications and changes may be made thereto by those skilled in the art without departing from the essential characteristics of the present invention. Therefore, the embodiments of the present invention are not intended to limit the technical spirit of the present invention but to illustrate the technical idea of the present invention, and the technical spirit of the present invention is not limited by these embodiments. The scope of protection of the present invention should be interpreted by the appending claims, and all technical ideas within the scope of equivalents should be construed as falling within the scope of the present invention.

1. A method for providing an original text and a translation thereof in a user terminal, the method comprising:
receiving, by the user terminal, an original text from a user;
performing an emoticon presenting and selecting operation of presenting, by the user terminal, emoticons classified by a plurality of items and allowing the user to select an emoticon; and
providing, by the user terminal, the selected emoticon together with the original text and a translation thereof.

2. The method of claim 1, wherein the emoticon presenting and selecting operation comprises:
presenting, by the user terminal, a plurality of items selectable by the user in a first region of a screen; and
presenting the emoticons classified by the plurality of items in a second region of the screen.

3. The method of claim 1, further comprising recommending, by the user terminal, to the user, one or more emoticons expected to be selected by the user by using a word or a sentence included in the original text or the translation.

4. The method of claim 1, further comprising recommending, by the user terminal, to the user, one or more emoticons calculated by using location information of the user terminal.

5. The method of claim 3 or 4, wherein the emoticon recommended to the user is calculated by machine learning.

6. The method of claim 1, further comprising providing, by the user terminal, a translation converted into a voice by reflecting the selected emoticon.

7. The method of claim 6, wherein the translation is converted into the voice by using voice conversion data corresponding to the selected emotion among a plurality of voice conversion data according to a plurality of emotion items stored in a database.

8. The method of claim 7, wherein the database includes a plurality of first voice conversion data classified according to the plurality of emotion items, and second voice conversion data commonly used regardless of the plurality of emotion items.

9. The method of claim 1, wherein some or all of the emoticons presented by the user terminal are emoticons whose shape changes with time.

10. A method by which a server provides an original text and a translation thereof by using a user terminal, the method comprising:
receiving, by the server, an original text inputted by a user from the user terminal;
providing, by the server, emoticons classified by a plurality of items to the user terminal; and
providing, by the server, a translation of the original text to the user terminal.

11. A computer program for executing each operation of claim 1 on a computer.

12. A user terminal for providing an original text and a translation thereof, the user terminal comprising:
an original text inputting unit configured to receive an original text from a user;
an emoticon presenting and selecting unit configured to classify and present emoticons by a plurality of items and allow the user to select an emoticon; and
a result providing unit configured to provide the selected emoticon together with the original text and a translation thereof.

13. A server for providing an original text and a translation thereof by using a user terminal, the server comprising:
an original text receiving unit configured to receive an original text inputted by a user from the user terminal;
an emoticon providing unit configured to provide emoticons classified by a plurality of items to the user terminal; and
a translation providing unit configured to provide a translation of the original text to the user terminal.
